(19) United States
(12) Patent Application Publication
(10) Pub. No.: US 2019/0383966 A1
(43) Pub. Date: Dec. 19, 2019

(54) Apparatus for forecasting of hydrometeor classification using numerical weather prediction model and method thereof

(71) Applicant: Korea Meteorological Administration, Seoul (KR)

(72) Inventors: Sung-Hwa Jung, Seoul (KR); In-Hae Cho, Seoul (KR); Hae-Lim Kim, Seoul (KR)

(21) Appl. No.: 16/388,809

(22) Filed: Apr. 18, 2019

(30) Foreign Application Priority Data
Apr. 19, 2018 (KR) 10-2018-0045412

(51) Int. Cl. G01W 1/10; G01W 1/06

(52) U.S. Cl. CPC G01W 1/10; G01W 1/06

(57) ABSTRACT

Disclosed are an apparatus for forecasting of hydrometeor classification using numerical weather prediction model and a method thereof. That is, a dual-polarized variables are generated using a numerical weather prediction model forecast field, the generated dual-polarized variables and a temperature of the numerical weather prediction model are interpolated, and then a hydrometeor is classified using fuzzy techniques to forecast information on the hydrometeors in the air in the future and forecast the information on the hydrometeors by a hydrometeor classification degree of an observation blank area.

### CROSS-REFERENCE TO RELATED APPLICATIONS

This application claims the priority of Korean Patent Application No. 10-2018-0045412 filed on Apr. 19, 2018, in the Korean Intellectual Property Office, the disclosure of which is incorporated herein by reference.

### BACKGROUND OF THE INVENTION

### Field of the Invention

The present invention relates to an apparatus for forecasting hydrometeor classification using a numerical weather prediction model and a method thereof, and more particularly, to an apparatus for forecasting hydrometeor classification using a numerical weather prediction model and a method thereof which generates a dual-polarized variables using a numerical weather prediction model forecast field, interpolates the generated dual-polarized variables and a temperature of the numerical weather prediction model, and then classifies a hydrometeor using fuzzy techniques.

### Description of the Related Art

Meteorological phenomena are closely related to life, and precise prediction of meteorological phenomena is an important issue in weather forecasting, dangerous weather disaster prevention, and air weather forecasting fields. In order to improve a prediction ability of the weather phenomena, a numerical forecasting system that reflects various parameters is required, and various methods for the numerical forecasting are being developed variously.

The most important source of information for numerical forecasting is radar information and results of researches such as precipitation estimation, wind field estimation, and first-time precipitation estimation are useful for weather forecasters to improve forecast accuracy using radar information and a computer in real time.

In order to classify hydrometeors, current hydrometeors are classified from the measured radar information by using fuzzy logic, but the hydrometeor classification in such a scheme focuses on division of types of hydrometeor, and as a result, there is a limit that it is low in accuracy and precision.

### SUMMARY OF THE INVENTION

The present invention has been made in an effort to provide an apparatus for forecasting hydrometeor classification using a numerical weather prediction model and a method thereof which generates a dual-polarized variables using a numerical weather prediction model forecast field, interpolates the generated dual-polarized variables and a temperature of the numerical weather prediction model, and then classifies a hydrometeor using fuzzy techniques.

The present invention has also been made in an effort to provide an apparatus for forecasting hydrometeor classification using a numerical weather prediction model and a method thereof which perform a remapper for a coordinate system of numerical weather prediction model information of and a coordinate system of radar observation information of different coordinate systems when generating dual-polarized variables using a numerical weather prediction model forecast field.

The present invention has also been made in an effort to provide an apparatus for forecasting hydrometeor classification using a numerical weather prediction model and a method thereof which calculate dual-polarized variables by considering each of temperatures of snow, a growing ice crystal, and soft hail when generating dual-polarized variables using a numerical weather prediction model forecast field.

An exemplary embodiment of the present invention provides a method for forecasting of hydrometeor classification using numerical weather prediction model, which includes: calculating, by a dual-polarized simulator, a drop size distribution based on a mixing ratio and a drop number of rain, snow, and soft hail included in the forecast field of the first numerical weather prediction model; calculating, by the dual-polarized simulator, dual-polarized variables using the calculated drop size distribution and a longitudinal drop scattering size calculated by a T-matrix scattering method; performing, by the dual-polarized simulator, remapper for brining information at a radar observation point from the forecast field of the numerical weather prediction model, in order to map a 3D grid coordinate system of the numerical weather prediction model and a coordinate system of the radar observational data; calculating, by a control unit, the temperature by inferring the altitude information of the dual polarization variable grid points and interpolating the upper and lower model vertical layers closest to the altitude; and selecting, by the control unit, the hydrometeor of which existence possibility is highest at each location by using the calculated dual polarization variables and the temperature of the numerical weather prediction model as an input variable of the fuzzy technique.

As an example related to the present invention, an axial ratio is applied to a T-matrix scattering method may be calculated in order to reflect a non-scattering effect for the hydrometeor.

As an example related to the present invention, in the calculating of the dual polarization variable data, reflectance included in the dual polarization variable may be calculated through the following equation,

$${Z}_{h , x} = \frac{4 {λ}^{4}}{{π}^{4} {\vert {K}_{w} \vert}^{2}} {\int }_{0}^{{D}_{ma x , x}} [ A {\vert {f}_{a , x} ( π ) \vert}^{2} + B {\vert {f}_{b , x} ( π ) \vert}^{2} + 2 C Re [ {f}_{a , x} ( π ) {f}_{b , x}^{*} ( π ) ] ] n ( D ) dD ( {mm}^{6} {m}^{- 3} ) , \\ {Z}_{v , x} = \frac{4 {λ}^{4}}{{π}^{4} {\vert {K}_{w} \vert}^{2}} {\int }_{0}^{{D}_{ma x , x}} [ B {\vert {f}_{a , x} ( π ) \vert}^{2} + A {\vert {f}_{b , x} ( π ) \vert}^{2} + 2 C Re [ {f}_{a , x} ( π ) {f}_{b , x}^{*} ( π ) ] ] n ( D ) dD ( {mm}^{6} {m}^{- 3} )$$

here, the A, B, and C may be as follows, and

A= [symbol] cos⁴Φ [symbol] =⅛(3+4 cos 2Φ̅e^{-2σ}^{²}+cos 4Φ̅e^{-8σ}^{²}),

B= [symbol] sin⁴Φ [symbol] =⅛(3−4 cos 2Φ̅e^{-2σ}^{²}+cos 4Φ̅e^{-8σ}^{²}),

C= [symbol] sin² cos²Φ [symbol] =⅛(1−cos 4Φ̅e^{-8σ}^{²}),

the ramda λ may represent a radar wavelength (e.g., 10.3 cm) and the Kw may represent a dielectric constant of water of 0.93, the maximum size D_{max,x} is 8 mm for rain drop D_{max,r}, 30 mm for snow drop D_{max,s}, and 70 mm for hail D_{max,h}, subscript x may be a type of hydrometeor drop, the fₐ(π) and f_{b}(π) may represent front scattering sizes depending on a long axis and a short axis, respectively, and the fₐ*(π) and f_{b}*(π) may represent a pair of front scattering sizes, respectively, the Re[ . . . ] may represent a real part of a complex number, the | . . . | may represent a variable size between single bars, and the < . . . > may represent an ensemble mean of a drop canting angle, and the Φ may represent a drop canting angle, the Φ̅ may represent a mean canting angle of the drop, and the σ may represent a standard deviation of the drop canting angle.

As an example related to the present invention, in the calculating of the dual polarization variable data, differential reflectance included in the dual polarization variable may be calculated through the following equation, and

$${Z}_{h , x} = \frac{4 {λ}^{4}}{{π}^{4} {\vert {K}_{w} \vert}^{2}} {\int }_{0}^{{D}_{ma x , x}} [ A {\vert {f}_{a , x} ( π ) \vert}^{2} + B {\vert {f}_{b , x} ( π ) \vert}^{2} + 2 C Re [ {f}_{a , x} ( π ) {f}_{b , x}^{*} ( π ) ] ] n ( D ) dD ( {mm}^{6} {m}^{- 3} )$$

a cross correlation coefficient included in the dual polarization variable may be calculated through the following equation.

$${Z}_{v , x} = \frac{4 {λ}^{4}}{{π}^{4} {\vert {K}_{w} \vert}^{2}} {\int }_{0}^{{D}_{ma x , x}} [ B {\vert {f}_{a , x} ( π ) \vert}^{2} + A {\vert {f}_{b , x} ( π ) \vert}^{2} + 2 C Re [ {f}_{a , x} ( π ) {f}_{b , x}^{*} ( π ) ] ] n ( D ) dD ( {mm}^{6} {m}^{- 3} )$$

As an example related to the present invention, in the performing of the remapper, the remapper may be performed by using a power-gain-based sampling vertical interpolation scheme.

As an example related to the present invention, the hydrometeor may have a cloud drop (CL), a drizzle (DRZ), a light rain (LR), a moderate rain (MR), a heavy rain (HR), hail (HA), hail/rain (HR), Graupel+Small hail (GSH), Graupel+Rain (GRR), dry snow (DS), wet snow (WS), ice crystal (IC), irregular ice crystal (IIC), and Suppercooled liquid droplet (SLD).

As an example related to the present invention, in the selecting of the hydrometeor of which existence possibility is highest at each location, the hydrometeor of which existence possibility is high at each location may be selected by combining the calculated dual polarization variable and a belonging function for the temperature at each location with respect to the belonging function for each input variable.

Another exemplary embodiment of the present invention provides an apparatus for forecasting of hydrometeor classification using numerical weather prediction model, which includes: a dual-polarized simulator calculating a drop size distribution based on a mixing ratio and a drop number of rain, snow, and soft hail included in the forecast field of the first numerical weather prediction model, calculating dual-polarized variables using the calculated drop size distribution and a longitudinal drop scattering size calculated by a T-matrix scattering method, and performing remapper for brining information at a radar observation point from the forecast field of the numerical weather prediction model, in order to map a 3D grid coordinate system of the numerical weather prediction model and a coordinate system of the radar observational data; and a control unit calculating the temperature by inferring the altitude information of the dual polarization variable grid points and interpolating the upper and lower model vertical layers closest to the altitude and selecting the hydrometeor of which existence possibility is highest at each location by using the calculated dual polarization variables and the temperature of the numerical weather prediction model as an input variable of the fuzzy technique.

As an example related to the present invention, the dual-polarized simulator may perform the remapper by using a power-gain based sampling vertical interpolating technique.

As an example related to the present invention, the control unit may select the hydrometeor of which existence possibility is high at each location by combining the calculated dual polarization variable and a belonging function for the temperature at each location with respect to the belonging function for each input variable.

According to an exemplary embodiment of the present invention, a dual-polarized variables are generated using a numerical weather prediction model forecast field, the generated dual-polarized variables and a temperature of the numerical weather prediction model are interpolated, and then a hydrometeor is classified using fuzzy techniques to forecast information on the hydrometeors in the air in the future and forecast the information on the hydrometeors by a hydrometeor classification degree of an observation blank area.

Further, according to an exemplary embodiment of the present invention, when the dual polarization variable is generated by using the forecast field of the numerical weather prediction model, a coordinate system of numerical weather prediction model information and a coordinate system of radar observation information of different coordinate systems are remapped, thereby increasing accuracy of determining the hydrometeor by using the forecast field of the numerical weather prediction model for hydrometeor classification.

In addition, according to an exemplary embodiment of the present invention, when the dual polarization variable is generated by using the forecast field of the numerical weather prediction model, the dual polarization variables are calculated by using considering each of the melting temperatures of snow, growing ice crystal, and powder snow, thereby increasing the accuracy of determining the hydrometeor.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a configuration of an apparatus for forecasting hydrometeor classification using a numerical weather prediction model according to an embodiment of the present invention;

FIG. 2 is a diagram illustrating an example of a trapezoidal membership function according to an embodiment of the present invention;

FIG. 3 is a diagram illustrating a relation between reflectance-differential reflectance, and reflectance-cross correlation coefficient depending on a two-dimensional membership function according to an embodiment of the present invention;

FIG. 4 is a flowchart of a method for forecasting hydrometeor classification using a numerical weather prediction model according to an embodiment of the present invention;

FIG. 5 is a diagram illustrating an example of reflectance calculated using a numerical weather prediction model forecast field according to an embodiment of the present invention;

FIG. 6 is a diagram illustrating an example of differential reflectance calculated using a numerical weather prediction model forecast field according to an embodiment of the present invention;

FIG. 7 is a diagram illustrating an example of a cross correlation coefficient calculated using a numerical weather prediction model forecast field according to an embodiment of the present invention;

FIG. 8 is a diagram illustrating an example of a temperature interpolated from a radar point according to an embodiment of the present invention; and

FIG. 9 is a diagram illustrating a result of forecasting hydrometeor classification using a numerical weather prediction model according to an embodiment of the present invention.

### DETAILED DESCRIPTION OF THE PREFERRED EMBODIMENT

It is noted that technical terms used in the present invention are used to just describe a specific embodiment and do not intend to limit the present invention. Further, unless the technical terms used in the present invention are particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that cannot accurately express the spirit of the present invention, the technical term is substituted by a technical term which can correctly appreciated by those skilled in the art to be appreciated. In addition, general terms used in the present invention should be analyzed as defined in a dictionary or according to front and back contexts and should not be analyzed as an excessively reduced meaning.

Moreover, if singular expression used in the present invention is not apparently different on a context, the singular expression includes a plural expression. Further, in the present invention, it should not analyzed that a term such as “comprising” or “including” particularly includes various components or various steps disclosed in the specification and some component or some steps among them may not included or additional components or steps may be further included.

In addition, terms including ordinal numbers, such as ‘first’ and ‘second’ used in the present invention can be used to describe various components, but the components should not be limited by the terms. The terms are used only for distinguishing one component from the other component. For example, a first component may be named as a second component and similarly, the second component may also be named as the first component without departing from the scope of the present invention.

Hereinafter, preferred embodiments according to the present invention will be described in detail with reference to the accompanying drawings, and like or similar components are denoted by the same reference numerals regardless of a sign of the drawing, and duplicated description thereof will be omitted.

In describing the present invention, when it is determined that detailed description relating to well-known functions or configurations may make the subject matter of the present disclosure unnecessarily ambiguous, the detailed description will be omitted. Further, it is noted that the accompanying drawings are used just for easily appreciating the spirit of the present invention and it should not be analyzed that the spirit of the present invention is limited by the accompanying drawings.

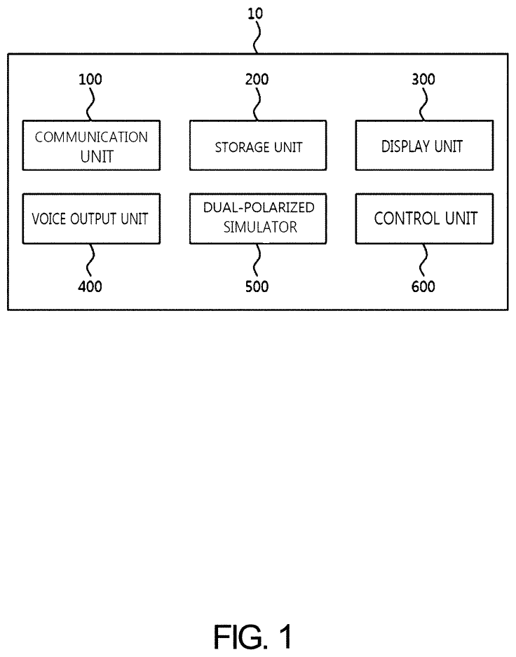

FIG. 1 is a block diagram of a configuration of an apparatus 10 for forecasting hydrometeor classification using a numerical weather prediction model according to an embodiment of the present invention.

As illustrated in FIG. 1, the apparatus 10 for forecasting hydrometeor classification includes a communication unit 100, a storage unit 200, a display unit 300, a voice output unit 400, a dual-polarized simulator 500, and a control unit 600. All components of the apparatus 10 for forecasting hydrometeor classification illustrated in FIG. 1 are not required components, but the apparatus 10 for forecasting hydrometeor classification may be implemented by more components than the components illustrated in FIG. 1 and may also be implemented by less components than the components illustrated in FIG. 1.

The apparatus 10 for forecasting hydrometeor classification may be applied to various terminals such as a smart phone, a portable terminal, a mobile terminal, a personal digital assistant (PDA), a portable multimedia player (PMP) terminal, a telematics terminal, a navigation terminal, a personal computer, a notebook computer, a slate PC, a tablet PC, an ultrabook, a wearable device (e.g., a smartwatch, a smart glass, a head mounted display (HMD), etc.), a Wibro terminal, an IPTV TV, an Internet Protocol Television (IPTV) terminal, a smart TV, a digital broadcasting terminal, an Audio Video Navigation (AVN) terminal, an Audio/Video (A/V) system, a flexible terminal, and the like.

The communication unit 100 communicates with any internal component or with at least one external terminal via a wired/wireless communication network. At this time, the external terminal may include a server (not illustrated). Here, a wireless Internet technology includes a wireless LAN (WLAN), a digital living network alliance (DLNA), a wireless broadband (Wibro), a world interoperability for a microwave (WiMAX), a high speed downlink packet access (HSDPA), a highspeed uplink packet access (HSUPA), IEEE 802.16, long term evolution (LTE), long term evolution-advanced (LTE-A), wireless mobile broadband service (WMBS), etc. The communication unit 100 transmits and receives data in accordance with at least one wireless Internet technology, including Internet technologies which are not listed above. Further, a short-range communication technology may include Bluetooth, Radio Frequency Identification (RFID), Infrared Data Association (IrDA), Ultra Wideband (UWB), ZigBee, Near Field Communication (NFC), Ultra Sound Communication (USC), Visible Light Communication (VLC), Wi-Fi, Wi-Fi Direct, etc. In addition, a wired communication technology may include power line communication (PLC), USB communication, Ethernet (Ethernet), serial communication, optical/coaxial cables, etc.

In addition, the communications unit 100 may mutually transmit information with any terminal via a universal serial bus (USB).

Further, communication unit 100 transmits and receives radio signals with a base station, the server, and the like on a mobile communication network constructed according to technical standards or communication methods of mobile communication (e.g., GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTE-A (Long Term Evolution-Advanced), etc.).

In addition, the communication unit 100 receives a forecast field of the numeral weather prediction model (or forecast data/forecast information of the numeral weather prediction model) transmitted from the server by a control of the control unit 600. In this case, the numeral weather prediction model may be a unified model (UM) global model. Here, the forecast field of the numeral weather prediction model may include primary prognostic variables generated at each grid point at a predetermined interval, second prognostic variables calculated from the primary prognostic variables by a parameterization scheme, auxiliary data required at a lower boundary of the numerical weather prediction model, tracers as passive variables drifted by the numerical weather prediction model, lateral boundary conditions, etc.

Further, the numerical weather prediction model is divided into a global model of forecasting a global area in a middle term and a local model of forecasting a specific local area with high resolution. Currently, in Korea, a UM global model developed in England has been used, and as a local model of East Asia, UM and weather research forecast (WRF) models have been used, and for ultra-short (or short)-term prediction, UM and Korea local analysis and prediction system (KLAPS) Korean Peninsula have been used.

Further, the numerical weather prediction model is configured by horizontal grid points of a grid point scheme model, and a vertical coordinate system uses a sigma coordinate system following the terrain near the ground instead of altitude Z and pressure level P coordinate systems and a hybrid coordinate system using an altitude coordinate system at a predetermined altitude or more. Each grid point is defined as land or sea, depending on the percentage occupied by the sea, and a sea ice area is defined using glacial boundary data.

In order to improve accuracy of an initial value of the numerical weather prediction model, observational data such as SYNOP, radiosonde, satellites, radars, etc. are used as input data, and observational data including a high error are excluded in a data assimilation process. The data assimilation is a process of making an analysis field by correcting a meteorological field forecasted by the numerical weather prediction model to observational data to make the initial input data of the numerical weather prediction model close to an actual atmosphere and a method for assimilation of 4-dimensional variables is used in the UM model.

Variables used in the numerical weather prediction model may be illustrated in Table 1 below.

TABLE 1

| Primary | Primary | Second | Auxiliary |
|---|---|---|---|
| prognostic | prognostic | prognostic | data |
| variable | variable | variable | |
| (atmosphere) | (ground) | | |
| u, v | p* (ground | Z_{H} (depth | Mask of land |
| (horizontal | pressure) | of boundary | and sea |
| wind component) | | layer) | |
| w (vertical | Tₛ (soil | Zₐ (roughness | Soil type |
| wind) | temper- | length of sea | |
| | ature) | surface) | |
| θ (potential | SMC (soil | CCₐ (amount | Vegetation |
| temperature) | moisture | of convective | type |
| | content) | cloud) | |
| q (specific | canopy | CC_{b} (base | Mean and |
| humidity) | moisture | of convective | dispersion of |
| | content | cloud) | terrain in |
| | | | grid box |
| qₜ, q_{f} (cloud | Snowdep | CCₜ (top | SST (sea |
| water, ice) | (amount of | of convective | surface |
| | snowfall) | cloud) | temperature) |
| | T* (temper- | Cₐ (amount | ICEc (ratio of |
| | ature of | of stratus) | sea ice) |
| | ground | | |
| | surface) | | |
| | | Ozone mixing | ICEt |
| | | ratio | (thickness of sea ice) |
| | | | Sea current |

In the embodiment of the present invention, it is described that the forecast field of the numerical weather prediction model is provided from the server, but is not limited thereto. The forecast field of the numerical weather prediction model at each grid point may be measured with the respect to the UM global model by a sensor unit (not illustrated) included in the apparatus 10 for forecasting the hydrometeor classification, respectively.

The storage unit 200 stores various user interfaces UIs, graphical user interfaces GUIs, etc.

In addition, the storage unit 200 stores data and programs required for operating the apparatus 10 for forecasting the hydrometeor classification.

That is, the storage unit 200 may store a plurality of application programs (or applications) driven in the apparatus 10 for forecasting the hydrometeor classification, and data and commands for operation of the apparatus 10 for forecasting the hydrometeor classification. At least some of these applications may be downloaded from an external server via wireless communication. Further, at least some of these applications may be present on the apparatus 10 for forecasting the hydrometeor classification from the time of release for basic functions of the apparatus 10 for forecasting the hydrometeor classification. Meanwhile, the application programs are stored in the storage unit 200 and installed in the apparatus 10 for forecasting the hydrometeor classification, and driven to perform an operation (or function) of the apparatus 10 for forecasting the hydrometeor classification by the control unit 600.

Further, the storage unit 200 may include at least one storage medium of a flash memory type, a hard disk type, a multimedia card micro type, a card type memory (e.g., SD or XD memory, etc), a magnetic memory, a magnetic disk (ROM), an optical disk, a random access memory (RAM), a static random access memory (SRAM), a read-only memory (ROM), an electrically erasable programmable read-only memory (EEPROM), and a programmable read-only memory (PROM). Further, the apparatus 10 for forecasting the hydrometeor classification may operate a web storage performing a storage function of the storage unit 200 on the Internet or operate in associated with the web storage.

Further, the storage unit 200 stores numeral weather prediction information received by the communication unit 100 and the like.

The display unit 300 may display various contents such as various menu screens using the user interface and/or the graphic user interface stored in the storage unit 200 by the control of the control unit 600. Here, the contents displayed on the display unit 300 includes various text or image data (including various types of information data), menu screens including data of icons, a list menu, a combo box, and the like. Further, the display unit 300 may be a touch screen.

Further, the display unit 300 may include at least one of a liquid crystal display (LCD), a thin film transistor liquid crystal display (TFT LCD), an organic light-emitting diode (OLED), a flexible display, a 3D display, an electronic ink display (e-ink display), and a light emitting diode (LED).

In addition, the display unit 300 displays the numerical weather prediction information received by the communication unit 100 by the control of the control unit 600.

The voice output unit 400 outputs voice information included in a predetermined processed signal by the control unit 600. Here, the voice output unit 400 may include a receiver, a speaker, a buzzer, and the like.

Further, the voice output unit 400 outputs a guidance voice generated by the control unit 600.

In addition, the voice output unit 400 outputs voice information corresponding to the numerical weather prediction information received by the communication unit 100 and the like by the control of the control unit 600.

The dual-polarized simulator 500 calculates dual-polarized variables based on the forecast field of the numerical weather prediction model.

That is, the dual-polarized simulator 500 serves to convert forecast data of the numerical weather prediction model into dual-polarized radar observational variables to convert the numerical weather prediction model data into a data form which is more intuitively determinable precipitation information. In this case, the variables of the numerical weather prediction model used as the input data in the dual-polarized simulator 500 require geographic information such as latitude and longitude, grid spacing, and a height for each model vertical layer, a temperature, a water vapor mixture ratio, and atmospheric pressure information for calculation of air density. In addition, speeds in east-west, south-north, and vertical directions of horizontal wind components (u, v) and a vertical wind component (w) are required in order to calculate a vision speed, and a mixing ratio of rain (qr), snow (qs), soft hail (qg), and hail (qh) and the number of drops thereof are required to calculate the dual-polarized variables.

Further, in the numerical weather prediction model, it is assumed that all hydrometeors are spherical, but the dual-polarized variables include information on a drop shape, and the dual-polarized simulator 500 reconfigures melting hydrometeors in which the drops are flattened.

Further, the dual-polarized simulator 500 calculates a drop size distribution n(D) based on the mixing ratio and the drop number Nt of rain, snow, and soft hail included in the forecast field of the numerical weather prediction model.

Further, the dual-polarized simulator 500 calculates dual-polarized variables (or dual-polarized radar observational variables) using the calculated drop size distribution and a longitudinal drop scattering size calculated by a T-matrix scattering method. In this case, in order to simulate the dual-polarized variables using the dual-polarized simulator 500, characteristic information of the drop such as a shape, a canting angle, and a density of a drop is required. Since it is difficult to clearly define these drop characteristics, in the embodiment of the present invention, when it is assumed that snow and hail fall horizontally in parallel with a long axis, it is assumed that a mean canting angle of the drop is 0°, standard deviation of canting angles of rain and snow drops are 0° and 20°, and the standard deviation of canting angle of dry hail is maximum 60°.

Further, in order to reflect a non-scattering effect for the hydrometeor, an axial ratio is applied to a T-matrix scattering algorithm (or a T-matrix scattering scheme) to calculate the longitudinal drop scattering size. At this time, the axial ratio is calculated according to an axial ratio relation of Equation 1 below in the case of rain and may use a fixed axial ratio (e.g., r=0.75) in the case of snowfall.

r=0.9951+0.0251D−0.03644D²+0.005303D³−0.0002492D⁴ [Equation 1]

Here, the r represents an axial ratio in the rain and the D represents a drop size.

Further, the dual-polarized simulator 500 calculates dual-polarized variables (or dual-polarized radar variables) such as a reflectance Z, a differential reflectance Z_{DR}, and a cross correlation coefficient ρₕᵥ by the following Equations 2 to 8.

$$\begin{matrix}{Z}_{h , x} = \frac{4 {λ}^{4}}{{π}^{4} {\vert {K}_{w} \vert}^{2}} {\int }_{0}^{{D}_{ma x , x}} [ A {\vert {f}_{a , x} ( π ) \vert}^{2} + B {\vert {f}_{b , x} ( π ) \vert}^{2} + 2 C Re [ {f}_{a , x} ( π ) {f}_{b , x}^{*} ( π ) ] ] n ( D ) dD ( {mm}^{6} {m}^{- 3} ) & [ Equation 2 ] \\ {Z}_{v , x} = \frac{4 {λ}^{4}}{{π}^{4} {\vert {K}_{w} \vert}^{2}} {\int }_{0}^{{D}_{ma x , x}} [ B {\vert {f}_{a , x} ( π ) \vert}^{2} + A {\vert {f}_{b , x} ( π ) \vert}^{2} + 2 C Re [ {f}_{a , x} ( π ) {f}_{b , x}^{*} ( π ) ] ] n ( D ) dD ( {mm}^{6} {m}^{- 3} ) & [ Equation 3 ] \\ A = 〈 {cos}^{4} Φ 〉 = \frac{1}{8} ( 3 + 4 cos 2 \overline{Φ} {e}^{- 2 {σ}^{2}} + cos 4 \overline{Φ} {e}^{- 8 {σ}^{2}} ) & [ Equation 4 ] \\ B = 〈 {sin}^{4} Φ 〉 = \frac{1}{8} ( 3 - 4 cos \overline{Φ} {e}^{- 2 {σ}^{2}} + cos 4 \overline{Φ} {e}^{- 8 {σ}^{2}} ) & [ Equation 5 ] \\ C = 〈 {sin}^{2} {cos}^{2} Φ 〉 = \frac{1}{8} ( 1 - cos 4 \overline{Φ} {e}^{- 8 {σ}^{2}} ) & [ Equation 6 ] \\ {Z}_{DR} = 10 {log}_{10} ( \frac{{Z}_{h}}{{Z}_{v}} ) = 10 {log}_{10} ( \frac{{Z}_{h , r} + {Z}_{h , rs} + {Z}_{h , ds} + {Z}_{h , rh} + {Z}_{h , dh}}{{Z}_{v , r} + {Z}_{v , rs} + {Z}_{v , ds} + {Z}_{v , rh} + {Z}_{v , dh}} ) dB & [ Equation 7 ] \\ {ρ}_{hv} = \frac{\vert {Z}_{hv , r} + {Z}_{hv , ds} + {Z}_{hv , dh} + {Z}_{hv , rs} + {Z}_{hv , rh} \vert}{( {[ \begin{matrix}( {Z}_{h , r} + {Z}_{h , ds} + {Z}_{h , dh} + {Z}_{h , rs} + {Z}_{h , rh} ) \\ ( {Z}_{v , r} + {Z}_{v , ds} + {Z}_{v , dh} + {Z}_{v , rs} + {Z}_{v , rh} )\end{matrix} ]}^{1 / 2} )} & [ Equation 8 ]\end{matrix}$$

Here, the ramda λ represents a radar wavelength (e.g., 10.3 cm) and the Kw represents a dielectric constant of water of 0.93. In addition, the maximum size D_{max,x} is 8 mm for rain drop D_{max,r}, 30 mm for snow drop D_{max,s}, and 70 mm for hail D_{max,h}. Here, subscript x is a type of hydrometeor drop and represents r (rain), rs (rain-snow mixture), ds (dry snow), rh (rain-hail mixture), dh (dry hail), and the like. In addition, the fₐ(π) and f_{b}(π) represent front scattering sizes depending on a long axis and a short axis, respectively, and the fₐ*(π) and f_{b}*(π) represent a pair of front scattering sizes, respectively. Further, the Re [ . . . ] represents a real part of a complex number, the | . . . | represents a variable size between single bars, and the < . . . > represents an ensemble mean of a drop canting angle. In addition, the Φ represents a drop canting angle, the Φ̅ represents a mean canting angle of the drop, and the σ represents a standard deviation of the drop canting angle.

At this time, in a melting layer model according to the embodiment of the present invention, melting temperatures of snow, growing ice crystal, and soft hail were differently set. In addition, a temperature of the melting layer of the snow according to the embodiment of the present invention was set as −2.5° C. to 2.5° C. at predetermined maximum to minimum heights, and the degree of melting of the snow within this range was considered (or assumed) in a linear relation to the temperature, and the maximum melting rate was considered as 0.8. The growing ice crystal was set as −5° C. to 0.4° C., the maximum melting rate at −5° C. was set to 0, and the maximum melting rate at 0.4° C. was set to 0.4. Further, a starting temperature of the melting layer of the soft hail was −5° C. and the maximum melting rate was set to 0.4. In other areas, the mixing ratio of snow and soft hail is 0.0 g/kg.

When the dual-polarized simulator 500 does not consider the melting layer, the cross correlation coefficient ρₕᵥ may be calculated using the following Equation 9 in a numerator of Equation 8 above and may be calculated using the following Equation 10 when considering the melting layer.

$$\begin{matrix}{Z}_{hv , x} = \frac{4 {λ}^{4}}{{π}^{4} {\vert {K}_{w} \vert}^{2}} {\int }_{0}^{{D}_{ma x , x}} [ C [ {\vert {f}_{a , x} ( π ) \vert}^{2} + {\vert {f}_{b , x} ( π ) \vert}^{2} ] + A [ {f}_{a , x} ( π ) {f}_{b , x}^{*} ( π ) ] + B [ {f}_{b , x} ( π ) {f}_{a , x}^{*} ( π ) ] ] n ( D ) dD ( {mm}^{6} {m}^{- 3} ) & [ Equation 9 ] \\ {Z}_{hv , x} = \frac{4 {λ}^{4}}{{π}^{4} {\vert {K}_{w} \vert}^{2}} \int n ( D ) [ [ {\vert {f}_{a} \vert}^{2} + {\vert {f}_{b} \vert}^{2} ] + 2 F [ \vert {f}_{a} \vert \vert {f}_{b} \vert {ρ}_{0 , x} ] ] n ( D ) dD ( {mm}^{6} {m}^{- 3} ) & [ Equation 10 ]\end{matrix}$$

Here, the E represents [symbol] sin²Φ cos²Φ [symbol] =⅛(1−cos 4Φe^{-8σ}^{²}) and the F represents [symbol] cos⁴Φ+sin⁴Φ [symbol] =⅛(3+cos 4Φ̅e^{-8σ}^{²}).

Further, the dual-polarized simulator 500 perform remapper for brining information at a radar observation point from the forecast field of the numerical weather prediction model, in order to map a 3D grid coordinate system of the numerical weather prediction model and a coordinate system of the radar observational data.

That is, generally, since the number of vertical layers of the numerical weather prediction model is larger than the number of the radar observation altitude angle, the dual-polarized simulator 500 perform remapper using the following Equation 11 as a power-gain-based sampling vertical interpolation scheme.

$${η}_{e} = \frac{\sum G {η}_{g} Δ Z}{\sum G Δ Z} \qquad [ Equation 11 ]$$

Here, the ηₑ represents an observation altitude, the η_{g} represents a vision speed or a reflectance value, and the ΔZ represents a depth of the layer with η_{g}.

The Equation 11 ignores an effect of a reflectance weight on vision speed observation, and the power-gain function G is assumed as Gaussian and shown in the following Equation 12.

$$G = exp [ - 4 ln 4 {( \frac{{Φ}_{g} - {Φ}_{0}}{{Φ}_{w}} )}^{2} ] \qquad [ Equation 12 ]$$

Here, the Φ_{w} represents a beam width, the Φ_{g} represents an altitude angle to the grid point, and the Φ₀ represents an altitude angle at the center of the beam. At this time, in this method, at least two numerical model vertical layers are required within the beam width.

The control unit 600 executes an overall control function of the hydrometeor classification predicting apparatus 10.

In this case, the control unit 600 executes the overall control function of the hydrometeor classification predicting apparatus 10 using programs and data stored in the storage unit 200. The control unit 600 may include a RAM, a ROM, a CPU, a GPU, and a bus and the RAM, the ROM, the CPU, and the GPU may be connected to each other via the bus. The CPU may perform booting using the 0/S stored in the storage unit 200 by accessing the storage unit 200 and perform various operations using various programs, contents, data, and the like stored in the storage unit 200.

Further, in order to identify and classify a precipitation drop in the air, the control unit 600 classifies the hydrometeors with respect to each pixel through the fuzzy technique by using the reflectance, differential reflectance, cross correlation coefficient, and the like calculated by the dual-polarized simulator 500 and the temperature data (or the temperature of the numerical weather prediction model) of the numerical weather prediction model as input data. In this case, the control unit 600 selects and classifies the hydrometeors corresponding to the maximum value by considering the belonging degrees and the weights for a total of 14 hydrometeors for each pixel.

That is, the control unit 600 calculates the temperature of the numerical weather prediction model by inferring the altitude information of the dual polarization variable lattice points and interpolating the upper and lower model vertical layers closest to the altitude. Here, the temperature field of the numerical weather prediction model plays an important role in classifying the hydrometeors by identifying a bright band altitude. However, the temperature field of the numerical weather prediction model is made up of a three-dimensional grid field and is different from the altitude information of the dual polarization variable lattice calculated through the dual polarized simulator 500. Accordingly, in order to use the temperature field of the numerical weather prediction model, a task is required, which adjusts temperature data for each grid. In this case, the altitude information (or radar beam center altitude) of the data corresponding to each lattice point is computed (or calculated) according to the distance from the center of the radar according to [Equation 13] below.

H=\sqrt{R²+Rₑ²+2RRₑ sin θ}−Rₑ+h [Equation 13]

Here, H denotes a radar beam center altitude, R denotes an observation distance from the radar, θ denotes a radar observation altitude angle, Rₑ denotes a radius of the earth (for example, 6371 km), h denotes a radar antenna altitude.

Further, the control unit 600 selects the hydrometeor of which existence possibility is highest at each location (or point/grid point, pixel) by using the calculated dual polarization variables (including, for example, reflectance, differential reflectance, cross correlation coefficient, etc.) and the temperature (or temperature data/result of interpolating the temperature of the numerical weather prediction model) of the numerical weather prediction model as an input variable of the fuzzy technique. Here, the hydrometeor has a cloud drop (CL), a drizzle (DRZ), a light rain (LR), a moderate rain (MR), a heavy rain (HR), hail (HA), hail/rain (HR), Graupel+Small hail (GSH), Graupel+Rain (GRR), dry snow (DS), wet snow (WS), ice crystal (IC), irregular ice crystal (IIC), Suppercooled liquid droplet (SLD), etc. In this case, the fuzzy technique is a technique of determining a result having a maximum value in a sum of degrees belonging to the results by expressing a probability for the result of each input variable in various types of functions.

That is, the control unit 600 calculates the hydrometeor of which existence possibility is high at the corresponding location by combining the calculated dual polarization variable and a belonging function for the temperature data (or the temperature of the numerical weather prediction model) at each location with respect to the belonging function for each input variable.

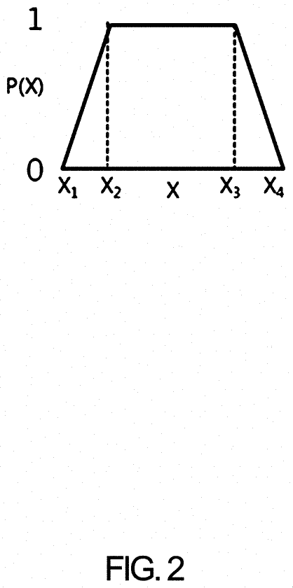

The type of belonging function in the function of [Equation 14] below uses a trapezoid as illustrated in FIG. 2.

Qᵢ=Σₖ₌₁⁴P_{i,k}Wₖ [Equation 14]

Here, the Qᵢ represents a degree that the hydrometeor exists, and the trapezoidal membership function P_{i,k} represents a probability that each hydrometeor exists when a variable value exists between X₁ to X₄ and represents a possibility as a value of 0 to 1. Further, at an interval of X₂ to X₃, the trapezoidal membership function P_{i,k} represents that there is a high probability of existing as a value of 1. That is, the trapezoidal membership function P_{i,k} represents a possibility (probability) that the hydrometeor exists for each type with respect to each of input variables (including the calculated reflectance, differential reflectance, cross correlation coefficient, the temperature, etc.) Further, the i represents 14 types of hydrometeor shapes such as 1: cloud, 2: drizzling rain, 3: weak rain, 4: common rain, 5: heavy rain, 6: hail, 7: hail/rain, 8: soft hail/small hail, 9: soft hail/rain, 10: dry snow, 11: wet snow, 12: ice crystal_isotropic, 13: ice crystal_anisotropic, and 14: supercooled water drop. In this case, the fuzzy technique is a technique for expressing the probability of the result of each input variable as various forms of functions and determining the result having the maximum value in the sum of the membership levels to the results as a final output product. In addition, the weight Wₖ may be a weight for the input variables and may have 20 in the reflection, 10 in the differential reflectance, 20 in the cross correlation coefficient, and 20 in the temperature.

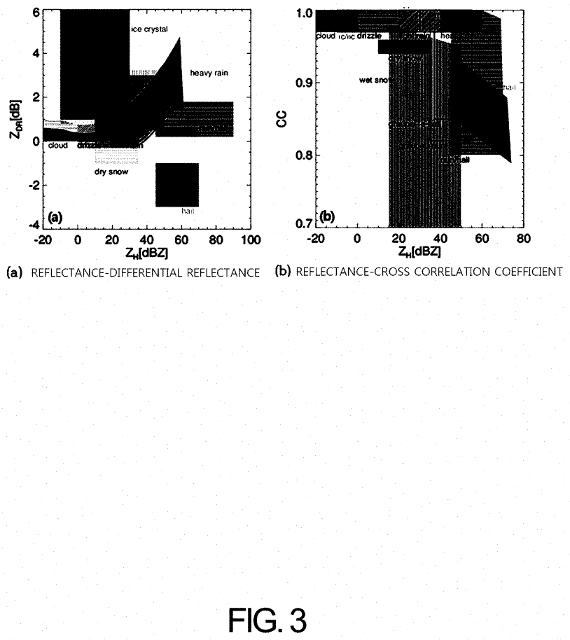

Further, as illustrated in FIG. 3, the trapezoidal membership function of FIG. 2 may be represented as a 2D membership function of a different dual-polarized variable for the reflection value.

Further, the control unit 600 outputs information on the hydrometeor classified for each location through the display unit 300 and/or the voice output unit 400.

In the embodiment of the present invention, it is described that the dual-polarized simulator 500 and the control unit 600 are separately constituted, but are not limited thereto, and the dual-polarized simulator 500 and the control unit 600 may be constituted as one component. That is, the control unit 600 is constituted by including the dual-polarized simulator 500 and may also perform various functions of the dual-polarized simulator 500.

As such, it is possible to generate dual-polarized variables using the forecast field of the numerical weather prediction model, interpolate the generated dual-polarized variables and the temperature of the numerical weather prediction model, and then classify the hydrometeor using the fuzzy technique.

Further, as such, when the dual-polarized variables are generated using the forecast field of the numerical weather prediction model, a remapper for a coordinate system of information on the numerical weather prediction model of different coordinate systems and a coordinate system of the radar observational information may be performed.

Further, as such, when the dual-polarized variables are generated using the forecast field of the numerical weather prediction model, the dual-polarized variables may be calculated by considering melting temperatures of snow, growing ice crystal, and soft hail.

Hereinafter, a method for forecasting hydrometeor classification using a numerical weather prediction model according to an embodiment of the present invention will be described in detail with reference to FIGS. 1 to 9.

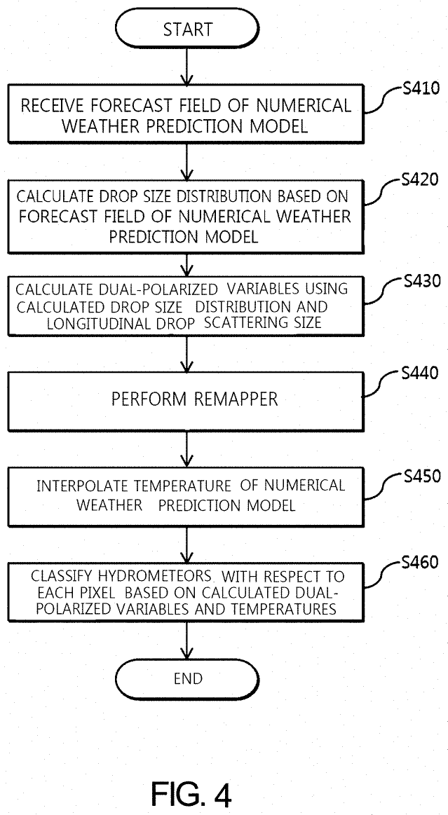

FIG. 4 is a flowchart illustrating a method for forecasting hydrometeor classification using a numerical weather prediction model according to an embodiment of the present invention.

First, the communication unit 100 receives a forecast field of the numeral weather prediction model (or forecast data/forecast information of the numeral weather prediction model) transmitted from a server (not illustrated). In this case, the numeral weather prediction model may be a unified model (UM) global model. Here, the forecast field of the numeral weather prediction model may include primary prognostic variables generated at each grid point at a predetermined interval, second prognostic variables calculated from the primary prognostic variables by a parameterization scheme, auxiliary data required at a lower boundary of the numerical weather prediction model, tracers as passive variables drifted by the numerical weather prediction model, lateral boundary conditions, etc.

As an example the communication unit 100 receives the forecast field of a first numerical weather prediction model measured at 3:00 PM on Mar. 1, 2017 using a UM local prediction model having a variable grid system at a resolution of 1.5 Km in the server (S410).

Thereafter, the dual-polarized simulator 500 calculates a drop size distribution n (D) based on the mixing ratio and the drop number Nt of rain, snow, and soft hail included in the forecast field of the numerical weather prediction model.

As an example, the dual-polarized simulator 500 calculates a first drop size distribution based on the mixing ratio and the drop number of rain, snow, and soft hail included in the forecast field of the first numerical weather prediction model(S420).

Thereafter, the dual-polarized simulator 500 calculates dual-polarized variables (or dual-polarized radar observational variables) using the calculated drop size distribution and a longitudinal drop scattering size calculated by a T-matrix scattering method. In this case, in order to simulate the dual-polarized variables using the dual-polarized simulator 500, characteristic information of the drop such as a shape, a slope, and a density of a drop and since it is difficult to clearly define the drop characteristics, in the embodiment of the present invention, it is assumed that the snow and hail fall horizontally in parallel to the long axis, and the average slope of the particle is 0°, a particle slope and a standard deviation of the rainfall and the snow particle are assumed as 0° and 20°, respectively and dry hail is assumed as a maximum of 60°.

Further, in order to reflect a non-scattering effect on the hydrometeor, an axial ratio is applied to a T-matrix scattering algorithm (or T-matrix scattering method) to calculate the front and back particle scattering magnitudes. In this case, the axis ratio may be calculated according to the axial ratio relationship of [Equation 1] for rainfall and a fixed axial ratio (for example, r=0.75) may be used for snowfall.

Further, the dual-polarized simulator 500 calculates each of dual polarization variables (or dual polarization radar variables) including reflectivity Z, differential reflectivity ZDR, a cross correlation coefficient ρhv, and the like through [Equation 2] to [Equation 8] above.

In this case, in a melting layer model according to an embodiment of the present invention, melting temperatures of snow, growing ice crystals, and soft hail are differently set. Further, the temperature of the melting layer of the snow according to an embodiment of the present invention is set at −2.5° C. to 2.5° C. at a predetermined maximum or minimum height, and the degree of fusion of the snow within the range is considered (or assumed), and the maximum fusion rate is considered to be 0.8. The temperature of the growing ice crystal is set to −5° C. to 0.4° C., and when the temperature is −5° C., the maximum fusion rate is set to 0 and when the temperature is 0.4° C., the maximum fusion rate is set to 0.4. Further, a start temperature of the melting layer of the soft hail is set to −5° C. and the maximum fusion rate is set to 0.4. In other zones, a mix ratio of the snow and the soft hail is 0.0 g/kg.

When the dual-polarized simulator 500 does not consider the melting layer, the cross correlation coefficient ρₕ, may be calculated using Equation 9 above in a numerator of Equation 8 above and may be calculated using Equation 10 above when considering the melting layer.

As an example, the dual-polarized simulator 500 each of reflectance Z, differential reflectance ZDR, and a cross correlation coefficient ρhv by using [Equation 2] to [Equation 8] above based on the calculated first drop size distribution and the longitudinal drop scattering size calculated by a T-matrix scattering method (S430).

Thereafter, the dual-polarized simulator 500 perform remapper for brining information at a radar observation point from the forecast field of the numerical weather prediction model, in order to map a 3D grid coordinate system of the numerical weather prediction model and a coordinate system of the radar observational data.

That is, generally, since the number of vertical layers of the numerical weather prediction model is larger than the number of the radar observation altitude angle, the dual-polarized simulator 500 performs remapper using Equation 11 above as a power-gain-based sampling vertical interpolation scheme.

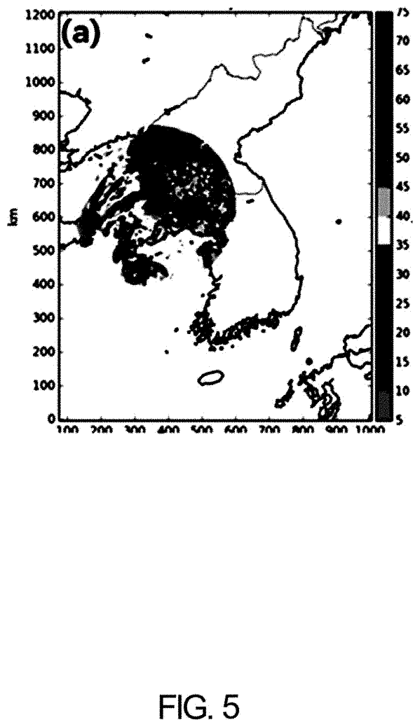

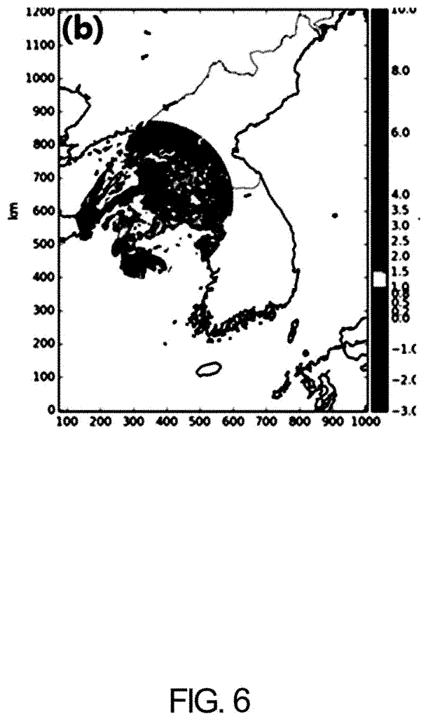

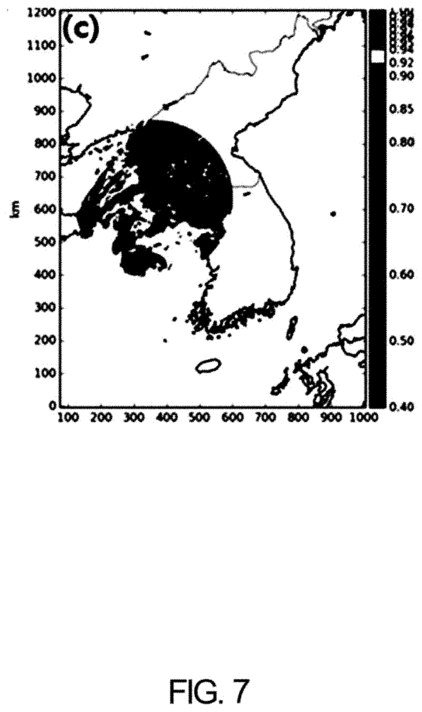

As an example, the dual-polarized simulator 500 performs remapper for brining information at a radar observation point from the forecast field of the numerical weather prediction model to finally calculate the reflectance illustrated in FIG. 5, finally the differential reflectance illustrated in FIG. 6, and finally calculate the cross correlation coefficient illustrated in FIG. 7.

Thereafter, the control unit 600 calculates the temperature by inferring the altitude information of the dual polarization variable grid points and interpolating the upper and lower model vertical layers closest to the altitude. Here, the temperature field of the numerical weather prediction model plays an important role in classifying the hydrometeor by discriminating a bright band altitude. However, the temperature field of the numerical weather prediction model is made up of a three-dimensional grid field and is different from the altitude information of the dual polarization variable grid calculated through the dual polarized simulator 500. Accordingly, in order to use the temperature field of the numerical weather prediction model, a task is required, which adjusts temperature data for each grid. In this case, the altitude information (or radar beam center altitude) of the data corresponding to each grid point is computed (or calculated) according to the distance from the center of the radar according to [Equation 13] above.

As an example, in the control unit 600, the numerical weather prediction model has temperature information for the three-dimensional grid points of x, y, and z, but as the radar data is distant from the radar center due to a earth curvature, an observation altitude increases and each observation point does not match x, y, and z points of the numerical weather prediction model, and as a result, x and y points of the temperature field of the numerical weather prediction model horizontally closet to each observation point of the radar are found based on the radar and layers above and below the beam center altitude are interpolated and the temperature for the corresponding altitude is inferred in order to acquire a temperature value for the radar altitude calculated above in a vertical direction (z direction) at the corresponding location.

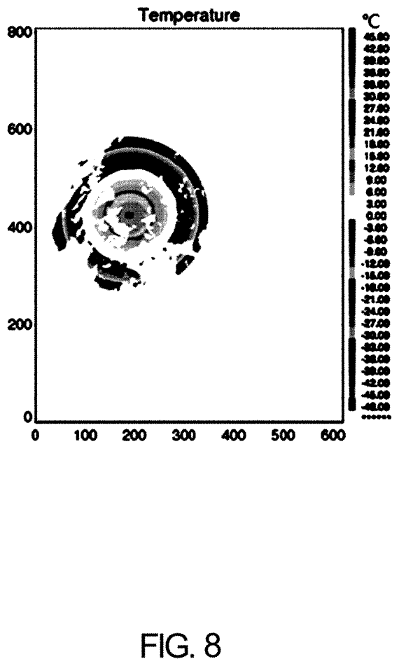

As a result, as illustrated in FIG. 8, the control unit 600 indicates an area up to 600 km on the x axis and an area up to 800 km on the y axis with the center (0,0) of Korean peninsular with respect to the x and y axes and shows a temperature value interpolated depending on the radar altitude observed by the radar in Baekryeong-do (S450).

Then, the control unit 600 selects the hydrometeor of which existence possibility is highest at each location (or point/grid point, pixel) by using the calculated dual polarization variables (including, for example, reflectance, differential reflectance, cross correlation coefficient, etc.) and the temperature (or temperature data/result of interpolating the temperature of the numerical weather prediction model) of the numerical weather prediction model as an input variable of the fuzzy technique. Here, the hydrometeor has a cloud drop (CL), a drizzle (DRZ), a light rain (LR), a moderate rain (MR), a heavy rain (HR), hail (HA), hail/rain (HR), Graupel+Small hail (GSH), Graupel+Rain (GRR), dry snow (DS), wet snow (WS), ice crystal (IC), irregular ice crystal (IIC), Suppercooled liquid droplet (SLD), etc. In this case, the fuzzy technique is a technique of determining a result having a maximum value in a sum of degrees belonging to the results by expressing a probability for the result of each input variable in various types of functions.

That is, the control unit 600 calculates the hydrometeor of which existence possibility is high at the corresponding location by combining the calculated dual polarization variable and a belonging function for the temperature data at each location with respect to the belonging function for each input variable.

In this case, in the function of [Equation 14] above, the type of the belonging function may adopt a trapezoid.

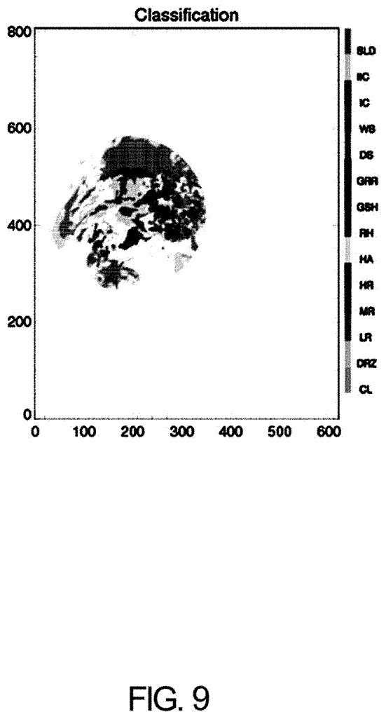

As an example, the control unit 600 classifies the hydrometeors by using the dual polarization variables (including reflectance, differential reflectance, cross correlation coefficient, etc.) calculated by using the forecast field of the numerical weather prediction model and the temperature (or the result of interpolating the temperature of the numerical weather prediction model) of the numerical weather prediction model and as illustrated in FIG. 9, the control unit 600 outputs a classification result of the hydrometeors.

As described above, the control unit 600 may calculate a Q value for each hydrometeor for each point and classify a largest Q value among the Q values for each hydrometeor at a specific point into the hydrometeor at the corresponding specific point (S460).

In the embodiment of the present invention, as described above, the dual polarization variable is generated by using the forecast field of the numerical weather prediction model, the generated dual polarization variable and the temperature of the numerical weather prediction model are interpolated and then, the hydrometeors are classified by using the fuzzy technique to forecast the information on the hydrometeor in advance and forecast the information as the hydrometeor classification degree of the observation blank area.

Further, in the embodiment of the present invention, as described above, when the dual polarization variable is generated by using the forecast field of the numerical weather prediction model, a coordinate system of numerical weather prediction model information and a coordinate system of radar observation information of different coordinate systems are remapped, thereby increasing accuracy of determining the hydrometeor by using the forecast field of the numerical weather prediction model for hydrometeor classification.

Further, in the embodiment of the present invention, as described above, when the dual polarization variable is generated by using the forecast field of the numerical weather prediction model, the dual polarization variables are calculated by using considering each of the melting temperatures of snow, growing ice crystal, and soft hail, thereby increasing the accuracy of determining the hydrometeor.

The aforementioned contents can be corrected and modified by those skilled in the art without departing from the essential characteristics of the present invention. Therefore, the exemplary embodiments of the present invention are provided for illustrative purposes only but not intended to limit the technical concept of the present invention. The scope of the technical concept of the present invention is not limited thereto. The protective scope of the present invention should be construed based on the following claims, and all the technical concepts in the equivalent scope thereof should be construed as falling within the scope of the present invention.

The present invention generates a dual polarization parameter using a forecast field of a numerical weather prediction model, interpolates the temperature of the generated dual polarization parameter and classifies hydrometeors using a fuzzy technique to forecast information on the hydrometeors in the air and forecast the information on the hydrometeors by a hydrometeor classification degree of an observation blank area and may be widely used in a weather forecasting field, a hazard weather control field, an air forecasting field, etc. by using the hydrometeors including snow, rain, hail, etc., in real time.

What is claimed is:

1. A method for forecasting of hydrometeor classification using numerical weather prediction model, comprising:
calculating, by a dual-polarized simulator, a drop size distribution based on a mixing ratio and a drop number of rain, snow, and soft hail included in the forecast field of the first numerical weather prediction model;
calculating, by the dual-polarized simulator, dual-polarized variables using the calculated drop size distribution and a longitudinal drop scattering size calculated by a T-matrix scattering method;
performing, by the dual-polarized simulator, remapper for brining information at a radar observation point from the forecast field of the numerical weather prediction model, in order to map a 3D grid coordinate system of the numerical weather prediction model and a coordinate system of the radar observational data;
calculating, by a control unit, the temperature by inferring the altitude information of the dual polarization variable grid points and interpolating the upper and lower model vertical layers closest to the altitude; and
selecting, by the control unit, the hydrometeor of which existence possibility is highest at each location by using the calculated dual polarization variables and the temperature of the numerical weather prediction model as an input variable of the fuzzy technique.

2. The method for forecasting of hydrometeor classification using numerical weather prediction model of claim 1, wherein an axial ratio is applied to a T-matrix scattering method is calculated in order to reflect a non-scattering effect for the hydrometeor.

3. The method for forecasting of hydrometeor classification using numerical weather prediction model of claim 1, wherein in the calculating of the dual polarization variable data,
reflectance included in the dual polarization variable is calculated through the following equation,
$${Z}_{h , x} = \frac{4 {λ}^{4}}{{π}^{4} {\vert {K}_{w} \vert}^{2}} {\int }_{0}^{{D}_{ma x , x}} [ A {\vert {f}_{a , x} ( π ) \vert}^{2} + B {\vert {f}_{b , x} ( π ) \vert}^{2} + 2 C Re [ {f}_{a , x} ( π ) {f}_{b , x}^{*} ( π ) ] ] n ( D ) dD ( {mm}^{6} {m}^{- 3} ) , \\ {Z}_{v , x} = \frac{4 {λ}^{4}}{{π}^{4} {\vert {K}_{w} \vert}^{2}} {\int }_{0}^{{D}_{ma x , x}} [ B {\vert {f}_{a , x} ( π ) \vert}^{2} + A {\vert {f}_{b , x} ( π ) \vert}^{2} + 2 C Re [ {f}_{a , x} ( π ) {f}_{b , x}^{*} ( π ) ] ] n ( D ) dD ( {mm}^{6} {m}^{- 3} )$$
here, the A, B, and C are as follows, and
A= [symbol] cos⁴Φ [symbol] =⅛(3+4 cos 2Φ̅e^{-2σ}^{²}+cos 4Φ̅e^{-8σ}^{²}),
B= [symbol] sin⁴Φ [symbol] =⅛(3−4 cos 2Φ̅e^{-2σ}^{²}+cos 4Φ̅e^{-8σ}^{²}),
C= [symbol] sin² cos²Φ [symbol] =⅛(1−cos 4Φ̅e^{-8σ}^{²}),
the ramda λ represents a radar wavelength (e.g., 10.3 cm) and the Kw represents a dielectric constant of water of 0.93, the maximum size D_{max,x} is 8 mm for rain drop D_{max,r}, 30 mm for snow drop D_{max,s}, and 70 mm for hail D_{max,h}, subscript x is a type of hydrometeor drop, the fₐ(π) and f_{b}(π) represent front scattering sizes depending on a long axis and a short axis, respectively, and the fₐ*(π) and f_{b}*(π) represent a pair of front scattering sizes, respectively, the Re[ . . . ] represents a real part of a complex number, the | . . . | represents a variable size between single bars, and the < . . . > represents an ensemble mean of a drop canting angle, and the Φ represents a drop canting angle, the Φ represents a mean canting angle of the drop, and the σ represents a standard deviation of the drop canting angle.

4. The method for forecasting of hydrometeor classification using numerical weather prediction model of claim 3, wherein in the calculating of the dual polarization variable data,
differential reflectance included in the dual polarization variable is calculated through the following equation, and
$${Z}_{h , x} = \frac{4 {λ}^{4}}{{π}^{4} {\vert {K}_{w} \vert}^{2}} {\int }_{0}^{{D}_{ma x , x}} [ A {\vert {f}_{a , x} ( π ) \vert}^{2} + B {\vert {f}_{b , x} ( π ) \vert}^{2} + 2 C Re [ {f}_{a , x} ( π ) {f}_{b , x}^{*} ( π ) ] ] n ( D ) dD ( {mm}^{6} {m}^{- 3} )$$
a cross correlation coefficient included in the dual polarization variable is calculated through the following equation.
$${Z}_{v , x} = \frac{4 {λ}^{4}}{{π}^{4} {\vert {K}_{w} \vert}^{2}} {\int }_{0}^{{D}_{ma x , x}} [ B {\vert {f}_{a , x} ( π ) \vert}^{2} + A {\vert {f}_{b , x} ( π ) \vert}^{2} + 2 C Re [ {f}_{a , x} ( π ) {f}_{b , x}^{*} ( π ) ] ] n ( D ) dD ( {mm}^{6} {m}^{- 3} )$$

5. The method for forecasting of hydrometeor classification using numerical weather prediction model of claim 1, wherein in the performing of the remapper,
the remapper is performed by using a power-gain-based sampling vertical interpolation scheme.

6. The method for forecasting of hydrometeor classification using numerical weather prediction model of claim 1, wherein the hydrometeor has a cloud drop (CL), a drizzle (DRZ), a light rain (LR), a moderate rain (MR), a heavy rain (HR), hail (HA), hail/rain (HR), Graupel+Small hail (GSH), Graupel+Rain (GRR), dry snow (DS), wet snow (WS), ice crystal (IC), irregular ice crystal (IIC), and Suppercooled liquid droplet (SLD).

7. The method for forecasting of hydrometeor classification using numerical weather prediction model of claim 1, wherein in the selecting of the hydrometeor of which existence possibility is highest at each location,
the hydrometeor of which existence possibility is high at each location is selected by combining the calculated dual polarization variable and a belonging function for the temperature at each location with respect to the belonging function for each input variable.

8. An apparatus for forecasting of hydrometeor classification using numerical weather prediction model, comprising:
a dual-polarized simulator calculating a drop size distribution based on a mixing ratio and a drop number of rain, snow, and soft hail included in the forecast field of the first numerical weather prediction model, calculating dual-polarized variables using the calculated drop size distribution and a longitudinal drop scattering size calculated by a T-matrix scattering method, and performing remapper for brining information at a radar observation point from the forecast field of the numerical weather prediction model, in order to map a 3D grid coordinate system of the numerical weather prediction model and a coordinate system of the radar observational data; and
a control unit calculating the temperature by inferring the altitude information of the dual polarization variable grid points and interpolating the upper and lower model vertical layers closest to the altitude and selecting the hydrometeor of which existence possibility is highest at each location by using the calculated dual polarization variables and the temperature of the numerical weather prediction model as an input variable of the fuzzy technique.

9. The apparatus for forecasting of hydrometeor classification using numerical weather prediction model of claim 8, wherein the dual-polarized simulator performs the remapper by using a power-gain based sampling vertical interpolating technique.

10. The apparatus for forecasting of hydrometeor classification using numerical weather prediction model of claim 8, wherein the control unit selects the hydrometeor of which existence possibility is high at each location by combining the calculated dual polarization variable and a belonging function for the temperature at each location with respect to the belonging function for each input variable.
